(19) United States
(12) Patent Application Publication
(10) Pub. No.: US 2003/0057800 A1
(43) Pub. Date: Mar. 27, 2003

(54) Pumping motor with skewed rotor laminations

(76) Inventor: Daniel Gizaw, Belleville, MI (US)

Correspondence Address: BROOKS & KUSHMAN, 1000 TOWN CENTER 22ND FL, SOUTHFIELD, MI, 48075

(21) Appl. No.: 09/965,048

(22) Filed: Sep. 26, 2001

(51) Int. Cl. H02K 1/22

(52) U.S. Cl. 310/261; 310/216

(57) ABSTRACT

This application relates to an improved motor for pumping fluid. The motor is improved by integrating a fluid pumping means within a rotor structure. Particularly, the laminations of a rotor are skewed into a fan or spiraling configuration. The rotor rotates in response to electromagnetic flux produced by a stator. During rotation the skewed rotor generate a propulsive force. When fluid is introduced to the skewed rotor, the propulsive force carries the fluid through the motor. A conduit is provided for directing at least some of the fluid flow.

### BACKGROUND OF THE INVENTION

1. Field of the Invention

This application relates to motors having skewed rotor laminations for pumping a fluid.

2. Background Art

The operation of motors, such as switched reluctance motors, induction motors, DC motors, permanent magnet synchronous motors, and salient pole synchronous motors, aw well known in the art.

However, for a number of application, and particularly automotive applications, there exists a need to pump fluid using a motor. Prior art methods of pumping a fluid have been known to use a motor in combination with an impeller. Such systems typically comprise a motor that separately supports the impeller in a portion remote from the internal structures of the motor. These systems are costly and lack efficiency. As such, a need exits for a motor arrangement capable of reducing costs and improving efficiency over motors having remotely positioned pumping agents.

### SUMMARY OF THE INVENTION

The present invention addresses the above-noted need by providing a motor pump having skewed rotor laminations integrally located within an interior of the motor for pumping a fluid.

In accordance with one aspect of the present invention, a motor for pumping fluid is provided including a stator having stator poles configured to produce electromagnetic flux when electrically energized, and a rotor having rotor poles allowing the rotor to rotate in response to the electromagnetic flux. The rotor poles include laminations which are sufficiently skewed for pumping fluid during rotation. A conduit is positioned between the stator and the rotor for substantially directing the fluid pumped by the rotor.

In accordance with another aspect of the present invention, a conduit provides a substantially air-tight seal with a stator and a rotor.

In accordance with another aspect of the present invention, a method is provided for pumping fluid including providing a motor having a stator and a laminated rotor that rotates relative to the stator, sufficiently skewing the rotor laminations to pump fluid through the motor when the rotor rotates, and confining the fluid around the rotor as it is pumped through the stator.

In accordance with another aspect of the present invention, calculations of fluid flow through the motor are improved due to increased sensitivity caused by the conduit controlling the fluid flow.

### BRIEF DESCRIPTION OF THE DRAWINGS

FIG. 1 is a perspective view of a pumping motor having skewed rotor laminations and a conduit according to the present invention;

FIG. 2 is an front elevation view of a rotor illustrating a skewed rotor according to the present invention;

FIG. 3 is a fragmentary perspective view of a rotor having skewed rotor laminations in a straight line skew configuration according to the present invention;

FIG. 4 is a fragmentary perspective view of a rotor having skewed rotor laminations in curved line skew configuration according to the present invention;

FIG. 5 is a perspective view of a conduit being a tube according to the present invention;

FIG. 6 is a front elevation view of the conduit FIG. 3 but with projections on the outer perimeter of the tube;

FIG. 7 is a perspective view of a pumping motor having skewed rotor laminations and a packed stator according to the present invention;

FIG. 8 is a top elevation view of a straight line skew configuration with a corresponding over-mold according to the present invention;

FIG. 9 is a top elevation view of a curved line skew configuration with a corresponding over-mold according to the present invention;

FIG. 10 is a perspective view of a pumping motor having skewed rotor laminations with a stator concentrically located within a rotor according to the present invention; and

FIG. 11 is a flow chart for a method of pumping fluid with a rotor having skewed rotor laminations according to the present invention.

### DETAILED DESCRIPTION OF THE PREFERRED EMBODIMENT(S)

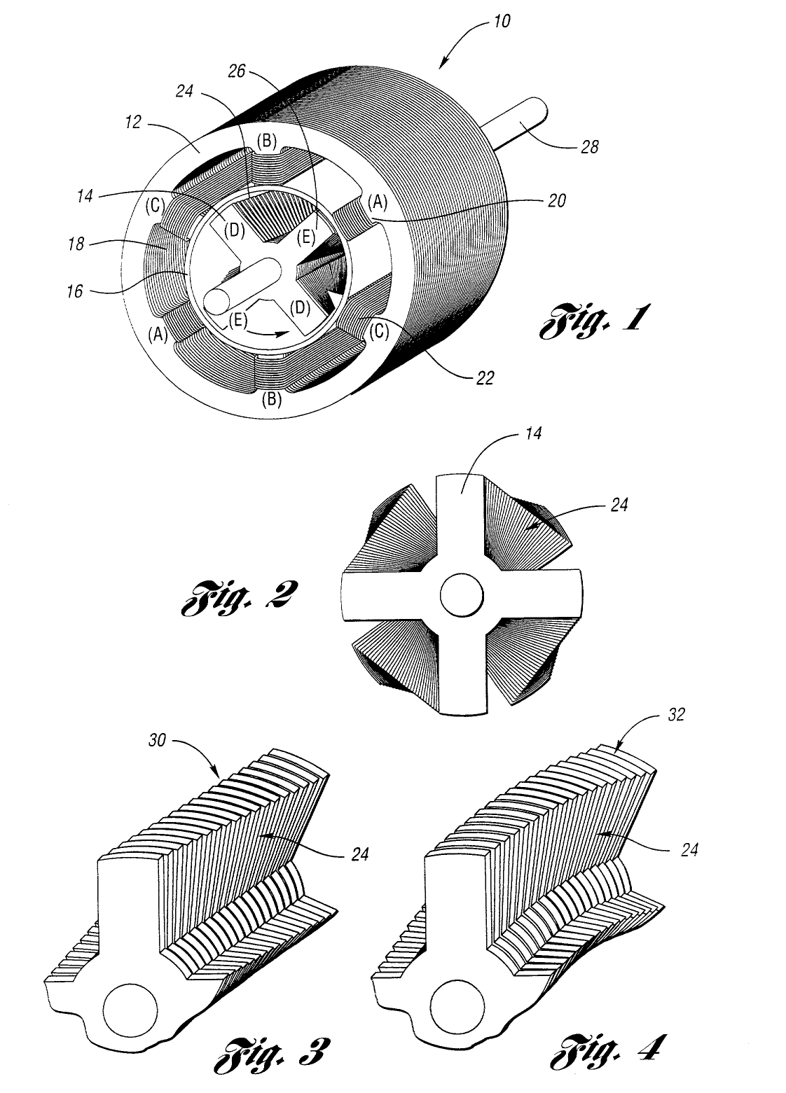

FIG. 1 indicates motor 10 according to an embodiment of the present invention. Motor 10 is preferably a switched reluctance motor. However, this invention works with other motors, such as an induction motor, a DC motor, a permanent magnet synchronous motor, and a salient pole synchronous motor. Motor 10 includes stator 12, rotor 14, and conduit 16.

Stator 12 comprises multiple layers of magnetized stator laminations 18. Stator laminations 18 typically have a thickness in the range of 0.001″-0.1″. Stator laminations 18 are arrangable into stator poles 20. Stator poles 20 extend along stator 12. Stator poles 20 are typically spaced apart from each other at equal intervals, and grouped in diametrically opposed pairs that depend on the number of desired phases. For example, a multi-phase system having three desired phase pairs A, B, C typically includes six stator poles 20. This system configuration is shown in FIG. 1. Each stator pole 20 is equally spaced at 60° intervals along the stator. If stator 12 had nine stator poles 20, each stator pole 20 would be equally spaced at 40° intervals. Stator poles 20 are wound with electrically conductive material 22, and each phase A, B, C is serially connected. Electromagnetic flux of an N-polarity or S-polarity is inducible within each phase A, B, C by electrically energizing conductive material 22.

Rotor 14 comprises multiple layers of magnetized rotor laminations 24. Rotor laminations 24 typically have a thickness in the range of 0.001″-0.1″. Rotor laminations 24 are arrangable into rotor poles 26. Rotor poles 26 extend along rotor 14. Rotor poles 26 are typically distanced from one another at equal intervals, and magnetized with diametrically opposing pairs D, E of an N-polarity or S-polarity. Each pair D, E has the same polarity, such that when read clockwise around the rotor the polarity of each pole 26 alternates between N-polarity and S-polarity. For example, each pole 26 is spaced at 90° of alternating N-polarity and S-polarity. If instead the rotor had six rotor poles 26, each pole 26 would be equally spaced at 60° intervals of alternating N-polarity and S-polarity.

Rotor 14 rotates about rotor shaft 28 when electromagnetic flux is produced. Generating electromagnetic flux is typically accomplished when one stator phase has an N-polarity excitation force of attraction, while one stator phase has an S-polarity excitation force of attraction and one stator phase has no excitation. For example, when phase A is excited with an attraction force of N-polarity, and phase B is excited with an attraction force of S-polarity, and phase C has no attraction force, the N-polarity of phase A attracts the nearest S-polarity rotor pole 26, the S-polarity of phase B attracts and the nearest N-polarity rotor pole 26, and phase C does not attract any pole 26. This action causes rotor 14 to rotate about the rotor shaft 28.

As illustrated in FIG. 2, rotor laminations 24 are typically offset from each other. The successively cascading offset of each lamination 24 produces a fan or spiraling shaped configuration along rotor 14.

As rotor 14 rotates, rotor laminations 24 interact with the fluid causing a pumping effect capable of propelling the fluid at desired velocities or pressures. In this manner, fluid flow is regulatable and controllable by the design of rotor 14 and conduit 16.

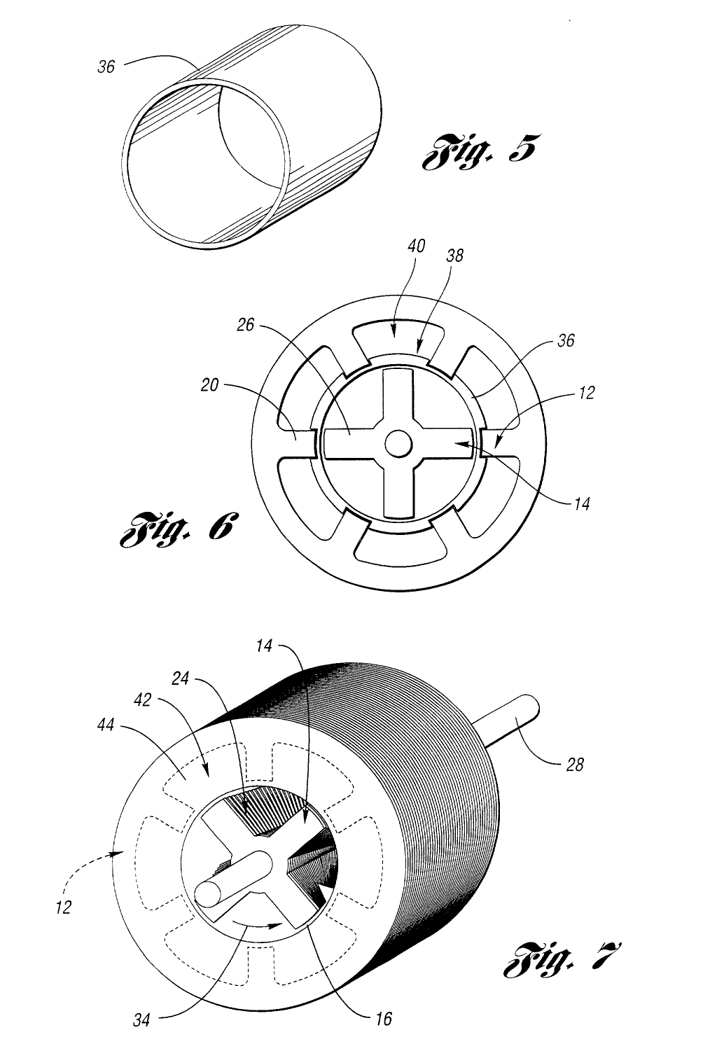

Rotor laminations 24 are orderable into a number of configurations, like those illustrated in FIGS. 3 and 4. FIG. 3 is a perspective view of rotor poles 26 having skewed rotor laminations 24 in straight line skew configuration 30. FIG. 4 is a perspective view of rotor poles 26 having skewed laminations 24 in curved line skew configuration 32. The selection of the particular skew configuration is determined based on desired performance characteristics.

The configuration of stator laminations 18 typically mirrors that of rotor 14. Meaning, stator 12 may have straight or curved poles 20. However, and depending on performance requirements, stator 12 is skewable in arrangements different from rotor 14. For example, when stator laminations 20 are not skewed in accordance with rotor laminations 24, the difference in respective configurations can be used to effect torque pulsation.

In operation, fluid interacts with rotor poles 26 to generate a propulsive force capable of pumping fluid along rotor 14. Liquid or gaseous fluids are all pumpable by the present invention.

Conduit 16 improves efficiency by substantially guiding or confining fluid in a directable and controllable manner. Fluid flow losses are thus reduced, and efficiency is improved. In all embodiments, conduit 16 preferable provides a substantially air-tight seal so that most of the fluid travels along rotor 14. Conduit 16 enhances the ability to calculate losses so that control factors are more reliable than those found in motor pumps not having an integral pumping agent surrounded by a substantially air-tight seal. In this fashion, conduit 16 is able to improve efficiency and enhance collection of reliable flow information.

As shown in FIG. 5, conduit 16 typically comprises tube 36. Tube 36 is attachable to stator 14 by a number of methods, including: a press-fit, a bolt, a tongue and groove, and a crimp. As shown in FIG. 6, tube 36 may also include interlocks 38 that extend into stator gaps 40.

Tube 36 is constructable with numerous materials depending on design characteristic. For example, when a design requires high electromagnetic attraction between stator poles 20 and rotor poles 26, tube 36 generally comprises a non-conducting material. Typical non-conducting materials include plastics, nylons, and ceramics. Other applications may not have such restraints, and therefore, other materials, such as conducting materials or metals may be used.

Fluid type particularly affects which tubing material is used. Abrasive or corrosive fluids require that the material tubing be selected accordingly.

As shown in FIG. 7, conduit 16 may also comprise packed stator 42. Packing is typically accomplished with a protective coating 44 that is applicable over stator 12 and within stator gaps 40.

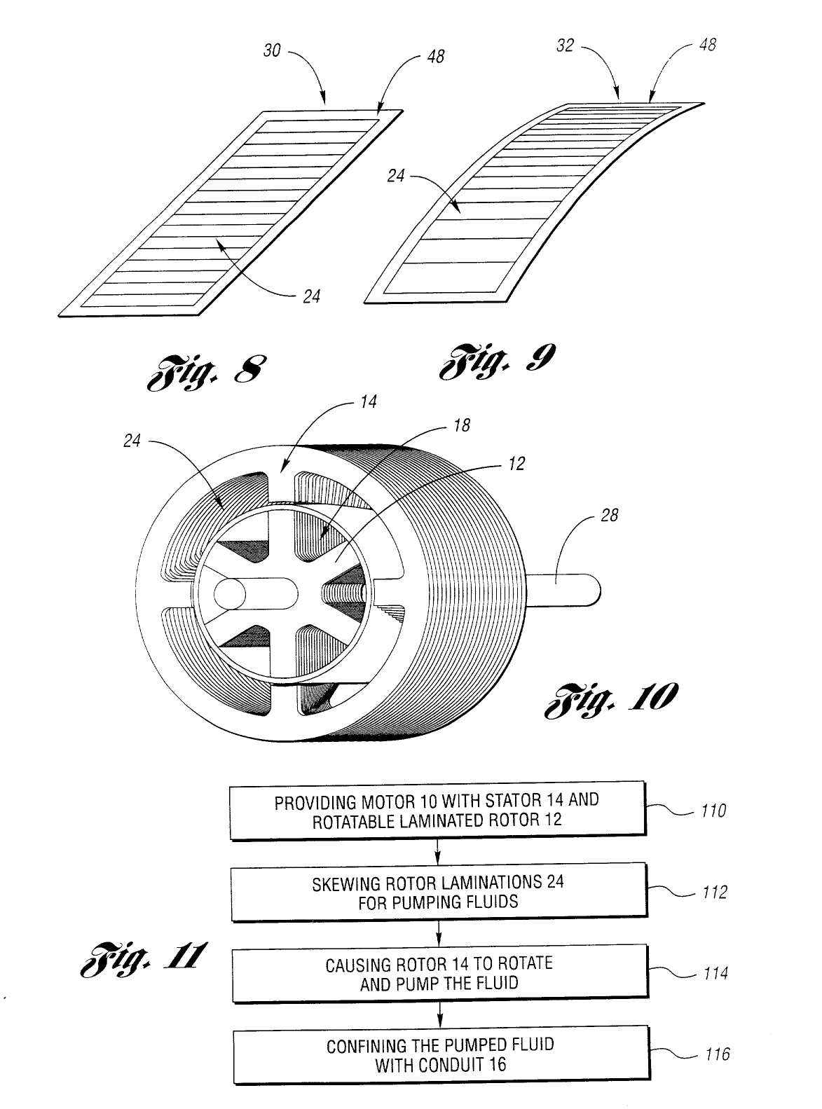

Rotor 14 is coatable with plastic 46 or other materials for effecting turbulence and flow performance. FIGS. 8 and 9 illustrate rotor coating 46 when applied to straight line configuration 30 and curved line configurations 32, respectively. Coating 46 generally includes an over-mold portion 48 that extends beyond rotor 14 for affecting fluid flow.

As shown in FIG. 10, a typical relationship of stator 12 and rotor 14 is reversed, meaning stator 12 is locatable concentrically within rotor 14. As such, rotor 14 has a larger diameter than stator 12. This system includes the aforementioned skewed rotor laminations 18, such that the larger rotor diameter increases the surface area for the skewed laminations, thus increasing the pressures and volumes for which fluid is moved.

As shown in FIG. 11, a flow chart for a method of pumping fluid is illustrated. Initially, at step 110 a motor 10 having stator 12 and rotatable laminated rotor 14 is provided. Next, at step 112, the rotor laminations 24 are sufficiently skewed for pumping fluid through motor 10 when the rotor 14 rotates. Then, at step 114, electrically conductive material 22 is energized to cause rotor 14 to rotate and pump the fluid. Finally, at step 116, the fluid flow control and efficiency is enhanced by confining the flow with conduit 16.

While the best mode for carrying out the invention has been described in detail, those familiar with the art to which this invention relates will recognize various alternative designs and embodiments for practicing the invention as defined by the following claims.

What is claimed:

1. A motor, comprising:
a stator having stator poles configured to produce electromagnetic flux when electrically energized;
a conduit positioned between the stator poles; and
a rotor positioned within the conduit and having rotor poles and rotatable in response to the electromagnetic flux, the poles having laminations sufficiently skewed for pumping fluid through the conduit during rotation.

2. The motor of claim 1, wherein the conduit comprises a tube.

3. The motor of claim 2, wherein the tube is affixed to the stator poles.

4. The motor of claim 3, wherein the outer circumference of the tube includes interlocks.

5. The motor of claim 2, wherein the tube is formed from plastic.

6. The motor of claim 2, wherein the tube is formed from metal.

7. The motor of claim 2, wherein the tube is non-magnetic.

8. The motor of claim 1, wherein the conduit comprises a packed stator.

9. The motor of claim 1, wherein the conduit is formed by a configuration of the stator.

10. The motor of claim 1, wherein the rotor includes a coating.

11. The motor of claim 1, wherein the motor comprises a switched reluctance motor.

12. The motor of claim 1, wherein the motor comprises an induction motor.

13. The motor of claim 1, wherein the motor comprises a permanent magnet synchronous motor.

14. The motor of claim 1, wherein the motor comprises a salient pole synchronous motor.

15. The motor of claim 1, wherein the motor comprises a DC motor.

16. The motor of claim 1, wherein the conduit provides a substantially air-tight seal for the fluid to flow along the rotor.

17. A motor having skewed rotor laminations for pumping fluid, the motor comprising:
a fixed stator having stator poles;
a rotatable rotor having sufficiently skewed laminations to move fluid when rotated; and
a conduit positioned between the stator and the rotor for substantially directing the moved fluid.

18. The motor of claim 20, wherein the conduit comprises a tube affixed to the stator.

19. A method for pumping fluid, the method comprising:
providing a motor having a stator and a laminated rotor rotatable relative to the stator;
skewing the rotor laminations sufficiently to pump fluid through the motor when the rotor rotates;
rotating the rotor to pump the fluid; and
confining the fluid around the rotor as the fluid is pumped.

20. The method of claim 19, further comprising confining the fluid with a conduit that produces a substantially air-tight seal as the fluid flows around the rotor and collecting reliable flow data on the pumped fluid.
